(19) United States
(12) Patent Application Publication
(10) Pub. No.: US 2015/0185330 A1
(43) Pub. Date: Jul. 2, 2015

(54) GNSS EXTENSION DEVICE

(71) Applicant: Hemisphere GNSS Inc., Scottsdale, AZ (US)

(72) Inventor: RODRIGO LEANDRO, SCOTTSDALE, AZ (US)

(73) Assignee: Hemisphere GNSS Inc., Scottsdale, AZ (US)

(21) Appl. No.: 14/587,277

(22) Filed: Dec. 31, 2014

Related U.S. Application Data
(60) Provisional application No. 61/922,561, filed on Dec. 31, 2013.

(51) Int. Cl. G01S 19/24

(52) U.S. Cl. CPC G01S 19/24

(57) ABSTRACT

Disclosed is GNSS extension device for use with portable devices in a Mapping and Geographical Information System (“MGIS”). The GNSS extension device includes a dual frequency GNSS antenna, a GNSS processing board for tracking and processing GNSS signals, a battery to sustain the GNSS processing board and antenna, and an application to manage GNSS device and position solution usage flow. The device also includes a portable device receiver to receive and retain a portable computing device, wherein the portable computing device executes instructions provided by the application. Thus the combination of the GNSS extension device and the portable computing device becomes a MGIS-like device.

### CROSS REFERENCE TO RELATED APPLICATION

This application claims priority to U.S. Provisional Patent Application to Rodrigo Leandro entitled “GNSS EXTENSION DEVICE,” Ser. No. 61/922,561, filed Dec. 31, 2013, now pending, the disclosure of which is hereby incorporated entirely herein by reference.

### BACKGROUND OF THE INVENTION

1. Technical Field

This invention relates generally to a GNSS device and more particularly to a GNNS extension device for use with portable devices in a Mapping Geographical Information System (MGIS).

2. State of the Art

An MGIS device includes a high end MGIS receiver that encapsulates a reasonably powerful GNSS board and computing processor. The GNSS antennas in high-end MGIS systems are typically ceramic antennas, which deliver very good signals in open sky, but have problems in challenging environments. These receivers typically provide the possibility of being connected to an external antenna. Once the high-end GNSS receiver is connected to the external antenna, they provide GNSS signals that are comparable to the signals from high end survey receivers. Because this type of receiver is reasonably complex, the market price is typically high. Another aspect is that such receivers often operate with an outdated operating system, which affects the usability experience of the user.

Another existing MGIS device includes low end receivers that are much like a smart phone. It uses the same grade of integrated GNSS chipsets and typically the same GNSS antenna grade as existing smart phones. The signal reception quality is lacking The advantages these devices possess are that they are typically ruggedized, and carry specific software to be used for typical MGIS user workflows. These MGIS devices typically do not employ a powerful processor; however they do not need it, since the GNSS signal tracking is taken care of already in the GNSS chipset. The application has only to deal with the pre-processed positions and their integration into the user workflow.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, the Figures are not necessarily drawn to scale, and:

FIG. 1 is a front view of a GNSS extension device coupled to a portable electronic device;

FIG. 2 is a side view of a GNSS extension device coupled to a portable electronic device showing internal components of the GNSS extension device;

FIG. 3A is a perspective view of a GNSS extension device with another type of portable electronic device coupled thereto;

FIG. 3B is a side view of the GNSS extension device of FIG. 3A;

FIG. 3C is an end view of the GNSS extension device of FIG. 3A;

FIG. 4 is a diagrammatic view of a GNSS processing board of a GNSS extension device;

FIG. 5 is a diagrammatic view of a portable computing device; and

FIG. 6 is a flow chart depicting a method of using a GNSS extension device.

### DETAILED DESCRIPTION OF EMBODIMENTS OF THE INVENTION

As discussed above, embodiments of the present invention relate to a GNSS extension device that is coupled to a portable computing device to enable the portable computing device to operate in a Mapping Geographical Information System (MGIS). An MGIS is used to capture, store, check, and display data related to positions on Earth's surface and show the collected or a portion of the collected data on a map. Often, the maps can include data layers, wherein each layer can be added or subtracted from a map.

The characteristics a user often desires from an MGIS device includes (1) moderate to low market price; (2) at least average signal quality, the option to use an external antenna as a possible additional element; (3) a powerful GNSS tracking and positioning engine; (4) a state-of-the-art operating system; (5) state-of-the-art user interaction hardware and software; and (6) a minimally ruggedized enclosure.

Embodiments take advantage of existing hardware and software that a user owns, providing the supplemental hardware and software in order to upgrade the user's device to a level similar to high-end MGIS receivers. These embodiments supplement a portable computing device with particular capabilities to operate in a MGIS. In other words, embodiments of a GNSS extension device convert a portable computing device into an MGIS device.

An embodiment includes a GNSS extension device comprising a GNSS antenna and a GNSS processing board having a memory and a processor for tracking and processing GNSS signals. The GNSS extension device may further comprise a battery to supply power to the GNSS processing board and GNSS antenna, and a software application to manage the GNSS device.

Another embodiment includes a GNSS extension device that includes a housing and a portable device receiver, a GNSS antenna located within the housing, and a GNSS processing board located within the housing. The GNSS processing board includes a memory and a processor for tracking and processing GNSS signals. The GNSS extension device further includes a battery retained within the housing, wherein the battery supplies power to the GNSS processing board and GNSS antenna. Additionally, embodiments include a software application stored in the memory of the GNSS processing board, wherein the software application includes instructions processed by the processor of the GNSS processing board to manage operation of the GNSS extension device. Further still, embodiments may include a portable computing device coupled within the portable device receiver, the portable computing device is in communication with the GNSS processing board, the GNSS processing board operating the instructions of the software application in response to receiving a second set of instructions from the portable computing device.

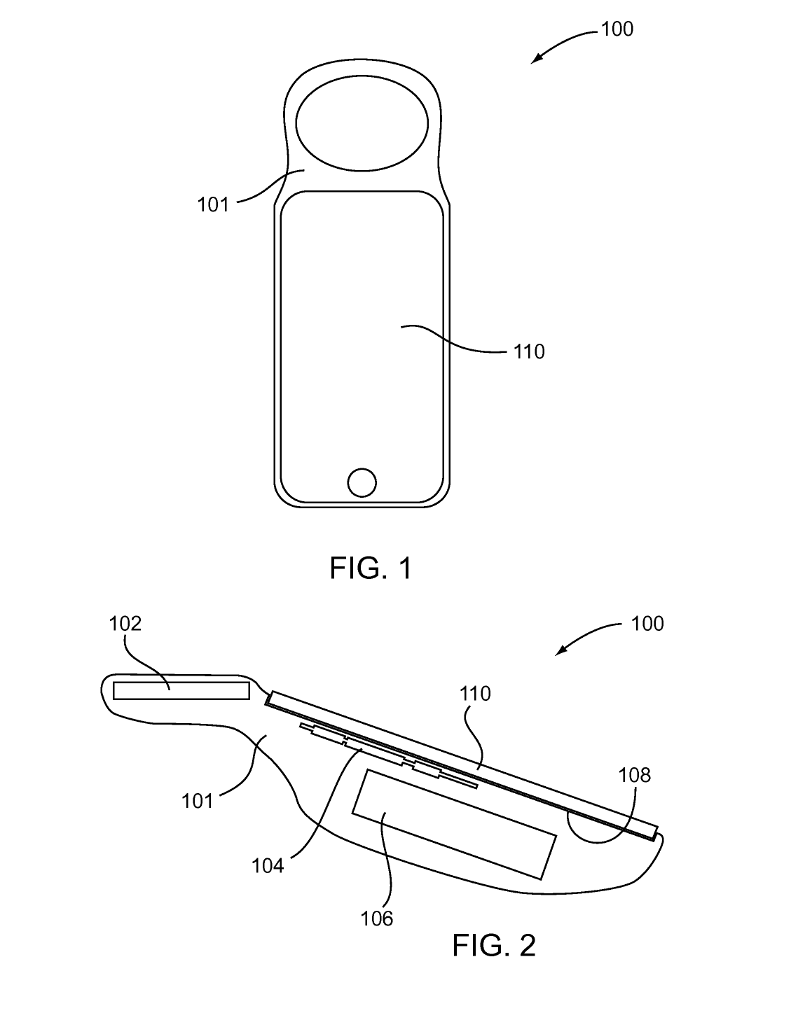

Referring to the drawings, FIGS. 1 and 2 depict an embodiment of a GNSS extension device 100. The GNSS extension device 100 comprises a housing 101, a GNSS antenna 102, which may be a single frequency or dual frequency antenna; a GNSS processing board 104 for tracking and processing GNSS signals; a battery 106 to sustain GNSS processing board 104 and antenna 102; and a software application to manage GNSS device 100 and position solution usage flow. The position solution usage flow includes tasks such as recording points and/or coordinates, features, or information data that refers to the user location. It might also include maps visualization as well as tasks such as guiding the user to reach a specific point coordinate with the receiver antenna. The GNSS extension device 100 further includes a portable device receiver 108 for receiving and retaining a portable computing device 110. In some embodiments, the portable computing device 110 is a smartphone. Further, in some embodiments, the GNSS extension device may further include a communication device (not shown) for establishing a communication connection between the GNSS extension device 100 and the portable computing device 110.

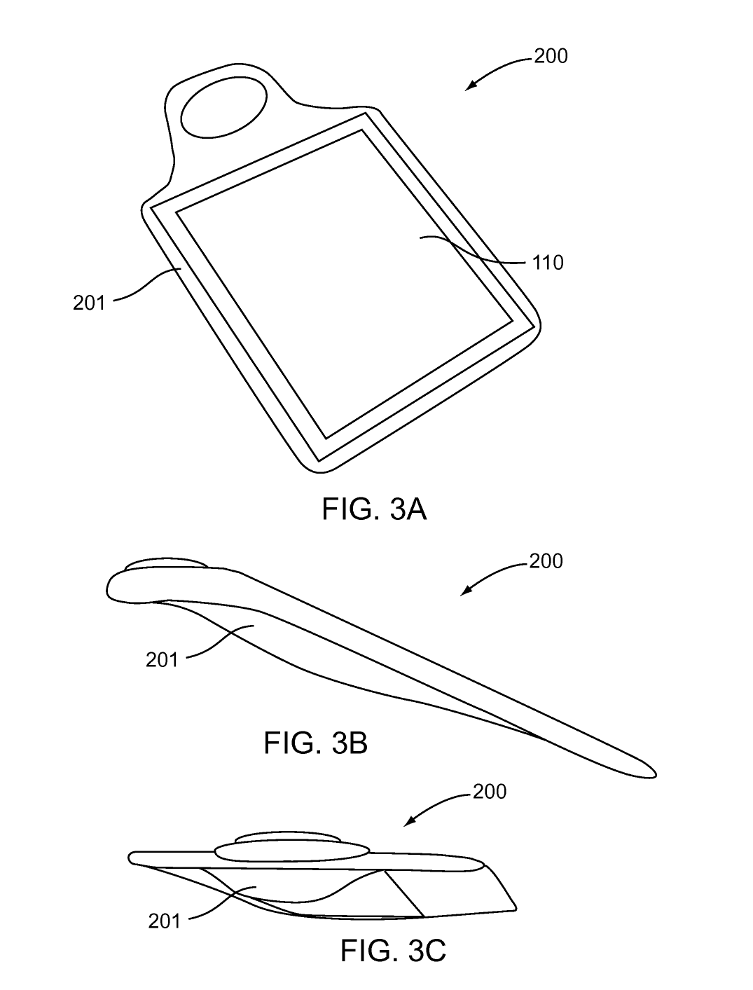

In other embodiments, as in FIGS. 3A-3C, the portable computing device 110 may be a tablet, with a GNSS extension device 200 configured to operate with a tablet. The GNSS extension device 200 may include a housing 201 having a size and shape to receive a tablet as the portable computing device 110.

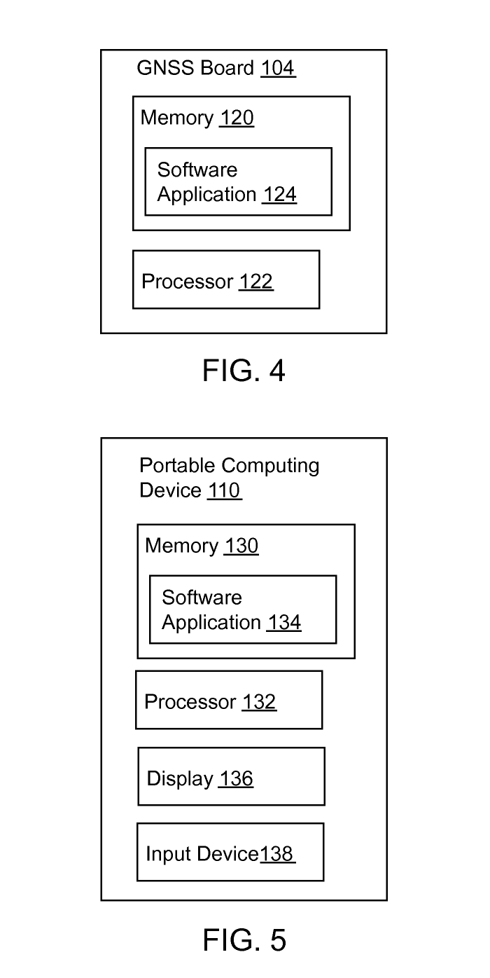

The GNSS processing board 104, as shown in FIG. 4, comprises a memory 120 and a processor 122, wherein the memory 120 stores a software application 124 containing instructions for operating the device 100, and the processor 122 of the GNSS processing board 104 processes the instructions of the software application 124 stored in the memory 120. The GNSS processing board 104 performs MGIS requested tasks, such as using a given set of correction data to achieve better accuracy. The user might also be able to configure the GNSS processing for his own needs, including options such as selecting satellites that should be tracked by the GNSS extension, selecting the dynamics mode of the positioning engine (i.e., static or kinematic), and so on. The user requested tasks are performed in response to receiving a second set of instructions from the portable computing device 110 to perform the MGIS tasks. Once the tasks are performed, the data resulting from the operation of the GNSS extension device 100 is send to the portable computing device 110 through a communication connection between the GNSS extension device 100 and the portable computing device 110. The data resulting from operation of the GNSS extension device 100 includes position data of the GNSS extension device 100. In some embodiments, position data includes a GNSS location.

In particular embodiments, the GNSS extension device 100 may include a wireless communication device, wherein the GNSS extension device 100 is in wireless communication with the portable computing device 110. This wireless communication may be Bluetooth, WIFI, near field communication (NFC) or other wireless protocols for communication. In other embodiments, the GNSS extension device 100 may include a wired connection with the portable computing device 110 in order to provide a communication connection between the portable computing device 110 and the GNSS extension device 100.

Referring further to FIG. 5, the portable computing device 110 includes a software application 134 stored in a memory 130 of the portable computing device 110. The portable computing device 110 may further include a display 136 and a user input device 138. The user input device 138 may be a touch screen that further operates as the display 136. The software application 134 operates on the portable computing device 110 by a processor 132 of the portable computing device 110 executing instructions of the software application 134 to request the GNSS extension device 100 to perform certain MGIS tasks. Operation of the software application 134 may be activated in response to a user providing input through the input device 138 to initiate operation of the software application 134. Once the MGIS tasks are completed by the GNSS device 100, position information generated by the GNSS extension device 100 is sent to the portable computing device 110. The portable computing device 110 may then display the position information in a usable format.

The GNSS extension device 100 allows for transforming a portable computing device 110 into a high precision MGIS device without the cost of a high-precision MGIS device. Additionally, the GNSS extension device 100 may operate with any operating system.

The GNSS extension device 100 could be used to leverage the technology a user already owns, providing a very cost-efficient way of giving the user access to high-end GNSS results for different applications. The leverage of the user interface hardware and software already employed in high-end phone and tablet devices might be an advantage with respect to the hardware/software available in specialized MGIS hardware.

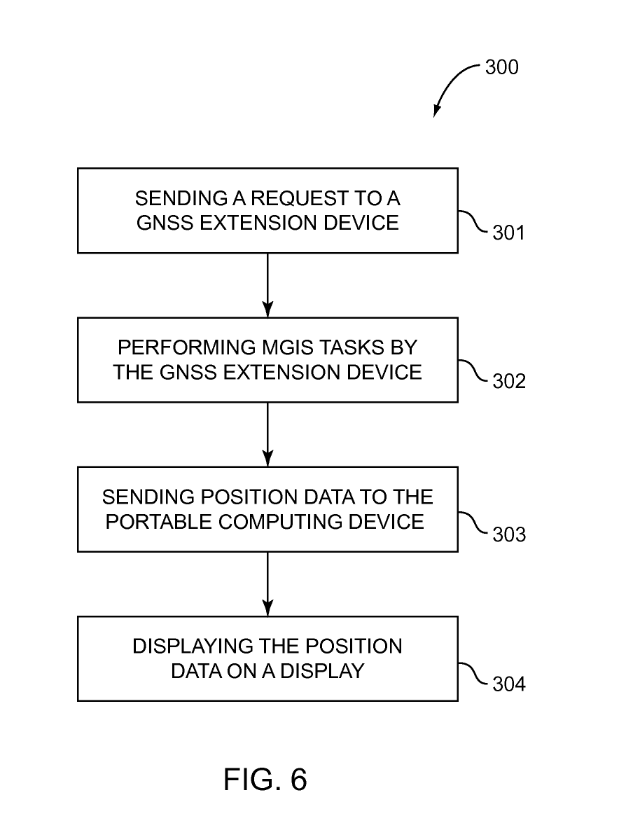

Referring again to the drawings, FIG. 6 depicts a method 300 of using a GNSS extension device in accordance with embodiments of the present invention. The method 300 comprises sending a request to a GNSS extension device in response to operating a software application on a portable computing device (Step 301); performing MGIS tasks by the GNSS extension device in response to receiving the request from the portable computing device (Step 302); sending position data to the portable computing device after performing the MGIS tasks (Step 303); and displaying the position data on a display of the portable computing device (Step 304).

The method 300 may include coupling the portable computing device within a portable device receiver of the GNSS extension device. The method 300 may also include establishing a communication connection between the portable computing device and the GNSS extension device. In some embodiments, establishing a communication connection may include establishing a wireless communication connection.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A GNSS extension device comprising:
a GNSS antenna;
a GNSS processing board having a memory and a processor for tracking and processing GNSS signals;
a battery to supply power to the GNSS processing board and the GNSS antenna; and
a software application stored in the memory of the GNSS processing board, wherein the software application includes instructions processed by the processor of the GNSS processing board to manage operation of the GNSS extension device.

2. The GNSS extension device of claim 1 further including a portable device receiver for receiving and retaining a portable computing device.

3. The GNSS extension device of claim 2, wherein the portable computing device is a smartphone.

4. The GNSS extension device of claim 2, wherein the portable computing device is a tablet.

5. The GNSS extension device of claim 2, further comprising a wireless communication device for communicating with the portable computing device.

6. The GNSS extension device of claim 5, further comprising a software application stored and operated on the portable computing device to send instructions to the GNSS extension device wirelessly when executed by the portable computing device.

7. The GNSS extension device of claim 6, wherein the software application of the GNSS extension device performs MGIS tasks in response to receiving instructions from the portable computing device.

8. The GNSS extension device of claim 7, wherein the GNSS extension device sends position data to the portable computing device wirelessly in response to executing the application stored in the memory of the GNSS processing board.

9. The GNSS extension device of claim 1, wherein the GNSS antenna is a single frequency antenna.

10. The GNSS extension device of claim 1, wherein the GNSS antenna is a dual frequency antenna.

11. A GNSS extension device comprising:
a housing comprising a portable device receiver;
a GNSS antenna located within the housing; and
a GNSS processing board located within the housing, the GNSS processing board having a memory and a processor for tracking and processing GNSS signals;
a software application stored in the memory of the GNSS processing board, wherein the software application includes instructions processed by the processor of the GNSS processing board to manage operation of the GNSS extension device; and
a portable computing device coupled within the portable device receiver, wherein the portable computing device is in communication with the GNSS processing board, and wherein the GNSS processing board operates the instructions of the software application in response to receiving a second set instructions from the portable computing device.

12. The GNSS extension device of claim 11, further comprising a battery retained within the housing, wherein the battery supplies power to the GNSS processing board and the GNSS antenna.

13. The GNSS extension device of claim 11, wherein the portable computing device is one of a smartphone or a tablet.

14. The GNSS extension device of claim 11, further comprising a communication device for communicating with the portable computing device.

15. The GNSS extension device of claim 11, further comprising a software application stored and operated on the portable computing device to send instructions to the GNSS extension device wirelessly when executed by the portable computing device.

16. The GNSS extension device of claim 15, wherein the GNSS extension device performs MGIS tasks in response to receiving instructions from the portable computing device.

17. The GNSS extension device of claim 16, wherein the GNSS extension device sends position data to the portable computing device in response to executing the application stored in the memory of the GNSS processing board.

18. The GNSS extension device of claim 11, wherein the GNSS antenna is a single frequency antenna.

19. The GNSS extension device of claim 11, wherein the GNSS antenna is a dual frequency antenna.

20. A method of using a GNSS extension device comprising:
sending a request to a GNSS extension device in response to operating a software application on a portable computing device;
performing MGIS tasks by the GNSS extension device in response to receiving the request from the portable computing device;
sending position data to the portable computing device after performing the MGIS tasks; and
displaying the position data on a display of the portable computing device.
